(19) United States
(12) Patent Application Publication
(10) Pub. No.: US 2005/0243975 A1
(43) Pub. Date: Nov. 3, 2005

(54) Method and system of determining unsolicited callers

(75) Inventors: David E. Reich, Jupiter, FL (US); Robert M. Szabo, Boca Raton, FL (US)

Correspondence Address: AKERMAN SENTERFITT, P. O. BOX 3188, WEST PALM BEACH, FL, 33402-3188, US

(73) Assignee: INTERNATIONAL BUSINESS MACHINES CORPORATION, ARMONK, NY (US)

(21) Appl. No.: 10/833,515

(22) Filed: Apr. 28, 2004

(51) Int. Cl. H04M 1/64; H04M 11/00

(52) U.S. Cl. 379/88.01; 379/88.14

(57) ABSTRACT

A method (10) of determining an unsolicited caller can include receiving (12) a call from a caller, requesting (15) a voice sample from the caller, analyzing (16) the voice sample using speech recognition to provide an analyzed voice sample which can be transcribed to provide a text output, and comparing (18) the text output with a database (20 or 22) of authorized callers. In a specific embodiment, the voice sample requested can include the name of the caller which is transcribed as text output and compared. The call can proceed (14) if the text output matches information in the database and can otherwise transfer to voice mail or terminate (30) if the text output fails to match information in the database or alternatively matches information indicating an undesired caller. If a caller with a known caller identification (13) is received, the call can also proceed.

### BACKGROUND OF THE INVENTION

1. Technical Field

This invention relates to the field of speech or voice recognition, and more particularly to a method and system for determining unsolicited callers.

2. Description of the Related Art

Unsolicited telephone calls from telemarketers and others continue to be an annoyance to most households. Even calls that have been solicited at one point in time become an disturbance at other times. The called party typically has the option of picking up the call or leaving an answering machine on all the time and returning calls later. Even with such existing features as Caller-ID that allows the called party to see the number of the caller (unless Caller-ID is blocked), the phone still rings and the caller needs to make an effort to recognize the calling party. With Caller-ID, if the number listed is unfamiliar, the called party does not have to pick it up and can allow an answering machine to handle the call. Again, although Caller-ID provides some peace of mind, it fails to prevent the phone from ringing and disturbing a called party since the called party also has to look at the caller-ID and decide if the call is desirable. If the Caller-ID is unrecognized, the called party may be further disturbed by having to call the number back. None of these options alleviate the annoying call in the first place or provide the convenience of talking to the desired people.

Yet another option is the so called “privacy director”, which allows calls through for pre-determined authorized callers (as set up by the called party) and otherwise asks the caller's name and rings the called party to see if they want to accept the call from the calling party. The call proceeds on a positive reply from the called party. Once again, the called party receives a call they still need to pick-up and answer. Although the called party does not directly get disturbed by the caller, the called party still gets disturbed by the call. A privacy director can also have the unintended effect of making desired callers go through verification particularly when they are calling from a place they usually don't call from.

### SUMMARY OF THE INVENTION

Embodiments in accordance with the invention can enable a method and system for processing an unsolicited call without necessarily disturbing a called party based on voice recognition and transcription in accordance with the present invention.

In a first aspect of the invention, a method of determining an unsolicited caller, can include the steps of receiving a call from a caller, requesting a voice sample from the caller, analyzing the voice sample using speech recognition to provide an analyzed voice sample, transcribing the analyzed voice sample to provide a text output, and comparing the text output with a database of authorized callers. In a specific embodiment, the voice sample requested can include the name of the caller which is transcribed as text output and compared with information in the database of authorized users. The method can further include the step of proceeding with the call from the caller if the text output matches information in the database. In one alternative, if the text output fails to match information in the database or alternatively matches information indicating an undesired caller, then the caller can be transferred to voice mail In another option, if the text output fails to match information in the database or alternatively matches information indicating an undesired caller, then the call can be terminated. The method can also include the step of determining if the call includes a known caller identification and proceeding with the call if the call includes the known caller identification and else requesting the voice sample from the caller. The method can also include the step of comparing the analyzed voice sample with a voice profile stored in a memory.

In a second aspect of the invention, a system for determining an unsolicited caller can include a memory and a processor. The processor can be programmed to receive a call from a caller, request a voice sample from the caller, analyze the voice sample using speech recognition to provide an analyzed voice sample, transcribe the analyzed voice sample to provide a text output, compare the text output with a database of authorized callers, and proceed with the call from the caller if the text output matches information in the database. The database can be local or can be accessible via a network. The processor can be further programmed to transfer the caller to voice mail if the text output fails to match information in the database or alternatively matches information indicating an undesired caller. In another alternative, the processor can be programmed to terminate the call if the text output fails to match information in the database or alternatively matches information indicating an undesired caller. The processor can also be programmed to determine if the call includes a known caller identification and proceed with the call if the call includes the known caller identification. If not, the processor can request the voice sample from the caller.

In a third aspect of the invention, a computer program has a plurality of code sections executable by a machine for causing the machine to perform certain steps as described in the method and systems outlined in the first and second aspects above.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a flow chart illustrating a method of determining unsolicited callers based on voice recognition and transcription in accordance with the present invention.

### DETAILED DESCRIPTION OF THE INVENTION

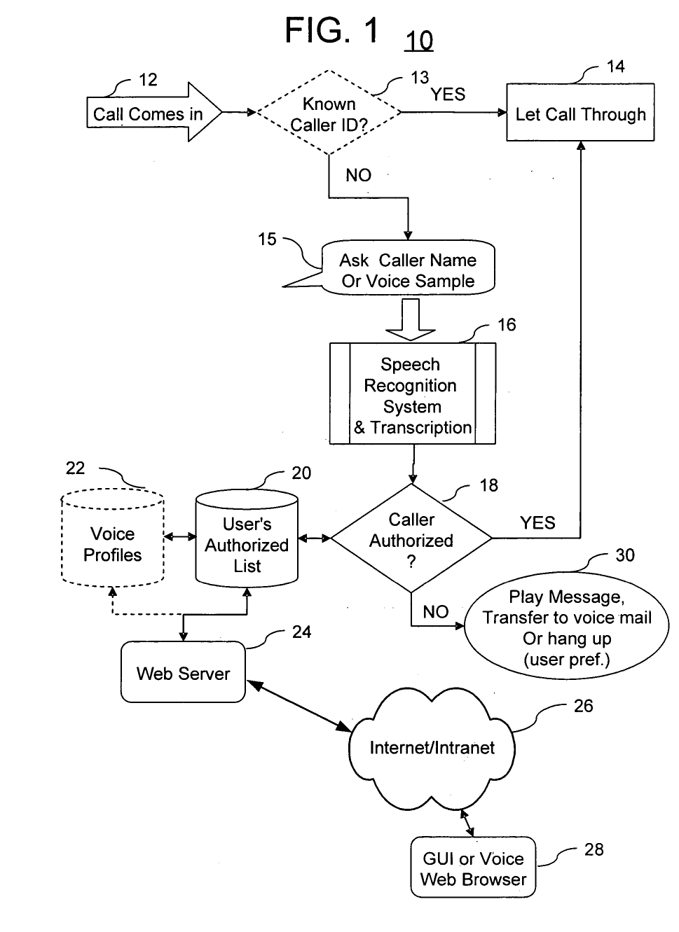

Embodiments in accordance with the invention can determine whether a caller is a desired caller using speech recognition and transcription. Referring to FIG. 1, a flow chart of a method 10 of determining an unsolicited caller is shown. At step 12, a call is received from a caller. At decision block 13, the method 10 optionally determines if the call includes a known Caller-ID. If the Caller-ID is known or predetermined (as can be determined by the called party), then the call proceeds at step 14. Otherwise, the method 10 can request a voice sample from the caller at step 15. The request can be a voice sample of the caller's name, but the invention is not necessarily limited to such sample. The voice sample can be a predetermined phrase being requested or a predetermined password only known between the caller and the called party. The method 10 can then include the step of analyzing the voice sample using a speech recognition system at block 16. The speech recognition system 16 can also transcribe the analyzed voice sample to provide a text output that can be compared at decision block 18 with information in a database. The information can include a user's authorized list 20 although alternatively or optionally the analyzed voice without transcription can be compared at decision block 18 with voice profiles 22. The user's authorized list 20 and the voice profiles 22 can be stored locally, but can also be accessible via a network such as through a web server 24 and the Internet or an intranet 26. Downloading and editing of the profiles or lists can be done via a GUI or voice web browser 28. The method 10 can further include the step of proceeding with the call from the caller at step 14 if the analyzed voice matches information in the database. In one alternative, if the analyzed voice fails to match information in the database or alternatively matches information indicating an undesired caller, then the caller can be transferred to voice mail or the call can be terminated as shown at step 30. This prevents a call from an unauthorized party from getting through, particularly where the unauthorized party attempts to masquerade as an authorized caller from the list of authorized callers.

In a specific embodiment, the voice sample requested can include the name of the caller which is transcribed as text output and compared with information in the database of authorized users. The method can further include the step of proceeding with the call from the caller if the text output matches information in the database. If the text output fails to match information in the database or alternatively matches information indicating an undesired caller, then the caller can be transferred to voice mail or the call can be terminated as discussed above.

The GUI or voice web browser 28 can include a user menu accessible through a web site on a web server 24 that can allow the user (called party) to type the names of any number of valid callers. The text of the names can be stored along with the calling party's number and placed in association with the user's phone number on a telephone carrier's system for example. Using a privacy director-like function, the caller's name is requested when the caller's number is not known. In this embodiment, rather than having the system ring through the call and disturb the called party, a speech recognition system can decode the utterance to text, match it to the user's authorized list, and let any valid callers through. The system can be further enhanced by putting in custom messages for certain callers to be spoken when they are identified. Such a system solves the problem of being disturbed for every call because only those in the database will be let through and only the calling party might be slightly inconvenienced when calling from unknown phone numbers by having to provide a voice sample.

It should be understood that the present invention can be realized in hardware, software, or a combination of hardware and software. The present invention can also be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program or application in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. A method of determining an unsolicited caller, comprising the steps of:
receiving a call from a caller;
requesting a voice sample the caller;
analyzing the voice sample using speech recognition to provide an analyzed voice sample;
transcribing the analyzed voice sample to provide a text output
comparing the text output with a database of authorized callers; and
proceeding with the call from the caller if the text output matches information in the database.

2. The method of claim 1, wherein the method further comprises the step of transferring the caller to voice mail if the text output fails to match information in the database or alternatively matches information indicating an undesired caller.

3. The method of claim 1, wherein the method further comprises the step of terminating the call if the text output fails to match information in the database or alternatively matches information indicating an undesired caller.

4. The method of claim 1, wherein the method further comprises the step of determining if the call includes a known caller identification.

5. The method of claim 4, wherein the method further comprises the step of proceeding with the call if the call includes the known caller identification and else requesting the voice sample from the caller.

6. The method of claim 1, wherein the step of requesting a voice sample comprises the step of requesting the name of the caller, the step of transcribing comprises the step of transcribing the name as the text output, and the step of comparing comprises comparing the name with the database of authorized users.

7. The method of claim 1, wherein the method further comprises the step of comparing the analyzed voice sample with a voice profile stored in a memory.

8. A system for determining an unsolicited caller, comprises:
a memory; and
a processor programmed to:
receive a call from a caller;
request a voice sample the caller;
analyze the voice sample using speech recognition to provide an analyzed voice sample;
transcribe the analyzed voice sample to provide a text output
compare the text output with a database of authorized callers; and
proceed with the call from the caller if the text output matches information in the database.

9. The system of claim 8, wherein the processor is further programmed to transfer the caller to voice mail if the text output fails to match information in the database or alternatively matches information indicating an undesired caller.

10. The system of claim 8, wherein the processor is further programmed to terminate the call if the text output fails to match information in the database or alternatively matches information indicating an undesired caller.

11. The system of claim 8, wherein the processor is further programmed to determine if the call includes a known caller identification, proceed with the call if the call includes the known caller identification and else request the voice sample from the caller

12. The system of claim 8, wherein the database of authorized callers is accessible via a network connection.

13. A machine-readable storage, having stored thereon a computer program having a plurality of code sections executable by a machine for causing the machine to perform the steps of
receiving a call from a caller;
requesting a voice sample the caller;
analyzing the voice sample using speech recognition to provide an analyzed voice sample;
transcribing the analyzed voice sample to provide a text output
comparing the text output with a database of authorized callers; and
proceeding with the call from the caller if the text output matches information in the database.

14. The machine-readable storage of claim 13, wherein the machine-readable storage is further programmed to transfer the caller to voice mail if the text output fails to match information in the database or alternatively matches information indicating an undesired caller.

15. The machine-readable storage of claim 13, wherein the machine-readable storage is further programmed to terminate the call if the text output fails to match information in the database or alternatively matches information indicating an undesired caller.

16. The machine-readable storage of claim 13, wherein the machine-readable storage is further programmed to determine if the call includes a known caller identification.

17. The machine-readable storage of claim 16, wherein the machine-readable storage is further programmed to proceed with the call if the call includes the known caller identification and else request the voice sample from the caller.

18. The machine-readable storage of claim 13, wherein the machine-readable storage is further programmed to compare the analyzed voice sample with a voice profile stored in a memory

19. The machine-readable storage of claim 13, wherein the machine-readable storage is further programmed to request the voice sample by requesting a name of the caller, transcribe by transcribing the name as the text output, and compare by comparing the name with the database of authorized users.
